(19) United States
(12) Patent Application Publication
(10) Pub. No.: US 2007/0267398 A1
(43) Pub. Date: Nov. 22, 2007

(54) Induction Heating of Footwear and Apparel

(76) Inventors: Anne McCoy, Chicago, IL (US); Matt Tijan, Northville, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/623,511

(22) Filed: Jan. 16, 2007

Related U.S. Application Data
(60) Provisional application No. 60/800,699, filed on May 16, 2006.

(51) Int. Cl. H05B 11/00

(52) U.S. Cl. 219/211

(57) ABSTRACT

A method is provided of inductively heating an apparel apparatus having an integrated heating element with copper and ferrous materials that is encased with a liquid material or a phase changing wax material. The apparel is positioned on an induction heating platform for an effective time period and then removed from the platform. Moreover, a method of manufacturing apparel is disclosed by forming the heating element, inserting it into the apparel, and providing consumers a kit with instructions on use of the apparel along with an induction heating platform. Further, the present invention encompasses an apparatus of consumer apparel containing the heating element, for example a pair of shoes worn by a user who stands on the inductive heating platform and then simply walks off with effectively warm shoes.

### CROSS-REFERENCE TO RELATED APPLICATIONS

This patent application claims the benefit of U.S. Provisional Patent Application No. 60/800,699, filed May 16, 2006.

### BACKGROUND OF THE INVENTION

There are a number of induction heating systems such as food-holding containers to maintain the temperature of the food during delivery. One example of such systems is disclosed in U.S. Pat. No. 6,232,585. There is a device and method for keeping meals warm disclosed in U.S. Pat. No. 6,841,764 as well as a method, device and receptacle for heating pre-prepared meals disclosed in U.S. Pat. No. 6,359,268 which also both use induction heating methods. There is also a device for the inductive heating of a tool-holder as disclosed in U.S. Pat. No. 6,822,206, In addition, there is an induction heating/vending system for heating, vending and recollecting stadium seats in U.S. Pat. No. 6,664,520. This system includes bulky heatable layers each sandwiched between alternating layers of solid-to-solid heat retentive material.

There presently exist foot warming methods that are currently available, none of which use inductive heat. These include resistive heat type products for warming the feet such as battery-operated heated socks (U.S. Pat. No. 4,705,935) and customizable heated insoles (U.S. Pat. No. 6,657,164). There are also pads which are inserted in footwear after heating them in the microwave. One such pad is disclosed in U.S. Pat. No. 5,591,221. However, battery operated footwear and apparel are limited in several regards. Generally batteries don't last more than a few hours and must be recharged prior to re-use. Also, battery operated footwear and apparel generally take a long time to heat up. Moreover, microwavable pads have disadvantages in that one must heat them first in a microwave prior to use, handle them while hot, and manipulate them with each use into any apparel. Obviously, microwave pads cannot be worn while heating them up.

Thus there is a need for an improvement related to heated footwear and apparel. As opposed to microwavable or battery operated thermal heat sources, a perpetual need exists for increased consumer convenience and efficiency, such that one does not have to replace/remove a pad or other heating element. One would wish to avoid an apparatus that requires replacement of its energy source such as in battery-operated footwear and apparel. One would also wish to unobtrusively maintain the integrity of conventional footwear and apparel and avoid modifications often associated with microwavable and resistive heating that undesirably alter the basic design and form of footwear and apparel to accept their respective heating elements.

### BRIEF SUMMARY OF THE INVENTION

Accordingly an object of the present invention is to provide a fast and efficient way to have warm footwear and apparel with minimal power consumption. Another object of the invention is to provide for wearer comfort by maintaining the integrity of the footwear and apparel without substantially modifying the design or altering the user's experience in relation to the heating device, such as by changing the sole of a shoe. Another object is to utilize the heating element in an insole that can be inserted in most conventional footware.

The present invention provides a method of inductively heating an apparel apparatus having an integrated heating element with copper clad ferrous material that is encased with a liquid material or a phase changing wax material. The apparel is positioned on an induction heating platform for an effective time period and then removed from the platform. In another embodiment, the invention is a method of manufacturing apparel by forming the heating element, inserting it into the apparel, and providing consumers a kit with instructions on use of the apparel along with an induction heating platform. In another embodiment, the invention is an apparatus of consumer apparel containing the heating element. In yet another embodiment, the invention is a pair of shoes worn by a user who stands on the inductive heating platform and then simply walks off the platform when the shoes are effectively warm.

At least one advantage of the present invention results from the fact that induction heating is generally one of the most efficient heating methods and requires minimal power compared to microwave power consumption, plug-in-the-wall systems, and/or battery operated footwear and apparel. Another advantage results from the lightweight, easy to use apparatus having a simple heating layer material encased in liquid or derived from wax, which provides unobtrusive comfort to any consumer user.

### BRIEF DESCRIPTION OF THE SEVERAL VIEWS OF THE DRAWING(S)

FIG. 1 is a drawing of a high temperature TEFLON bag.

FIG. 2 is a drawing of a ferrous material with copper cladding used to form a heating element.

FIG. 3 is a heating element comprising a copper compound and a ferrous compound shown in a high temperature TEFLON bag that is filled with a liquid encasing fluid for heat transfer, and the bag is shown mechanically sealed.

FIG. 4 is a side view of FIG. 3.

FIG. 5 shows a schematic of a shoe insole with a silicone jacket and the dotted lines mark the location of a heating element.

FIG. 6 shows three views of heating element located in a footwear apparatus.

FIG. 7 shows an induction heating platform.

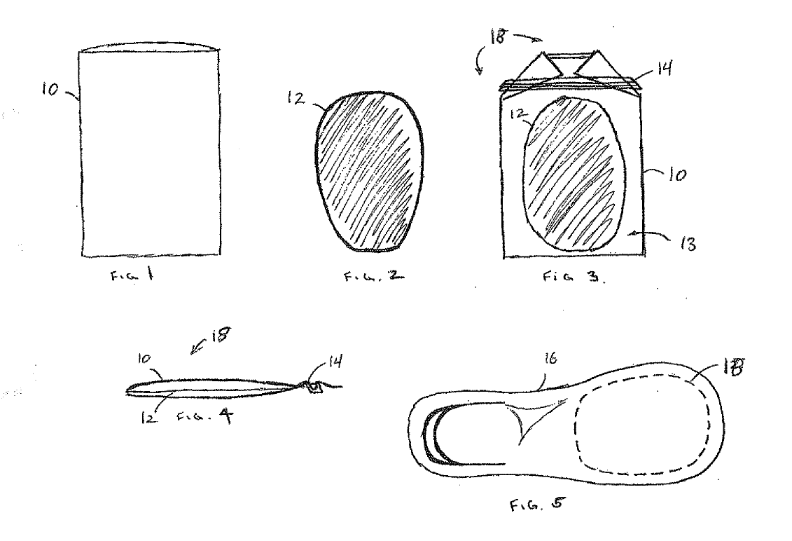

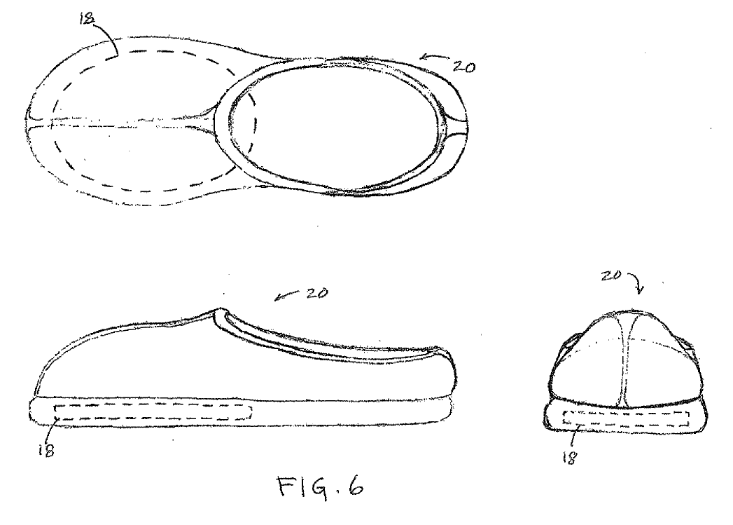

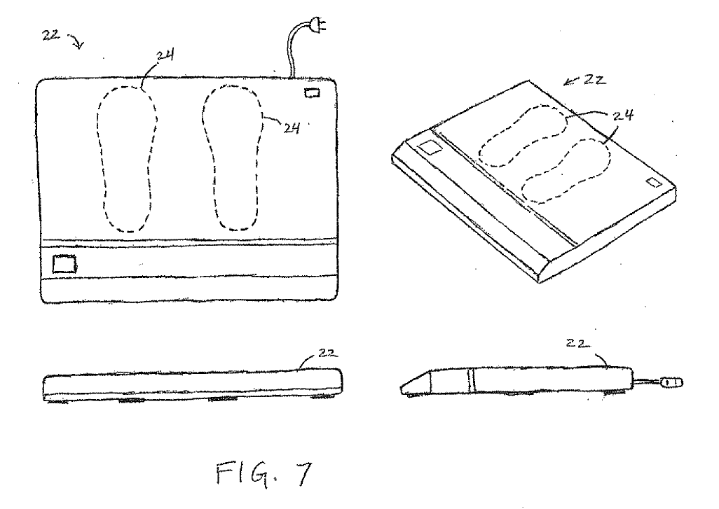

### DETAILED DESCRIPTION OF THE INVENTION

As stated above, the present invention provides a method of inductively heating an apparel apparatus, a method of manufacturing apparel with a heating element, and an apparel apparatus suitable for efficient and convenient heating. First, the apparel apparatus can be a convenient article for consumer use, including but not limited to items such as hats, shirts, sweaters, pants, mittens, gloves, underwear, socks, shoes, slippers, insoles, boots, jackets, coats, blouses, dresses, suits, belts, scarves, ties, and combinations thereof. Such items of consumer apparel are preferably footwear such as shoes, slippers, insoles or boots. Second, the apparatus also has an integrated heating element as an essential component. The heating element is generally a metallic material compound formed by using at least a ferrous compound and a copper compound. Preferably the copper compound is used as a cladding for the ferrous compound. Other metallic materials known to the art also are suitable for use in the heating element. The heating element is also encased in a liquid heat transfer material that is optionally derived from wax. When wax, such as paraffin wax, is used as the liquid encasing material, it is suitably chosen so as to undergo a phase transition between solid state and liquid state when acted upon under inductive heating conditions. Alternatively, the liquid encasing material is a heat transfer liquid with an effectively high heat capacity in order to retain heat when acted upon under inductive heating conditions. Heat transfer liquid also preferably is non-toxic and has an effectively high flash point in order to provide consumer safety. Such an effectively high flash point and heat capacity is determined based on the particular configuration of the apparel, including the location of the heating element in spatial relation to any inductive heating platform used. Generally, applicants have found that an effectively high flash point is at least about 350° F. or higher, and includes materials derived from oil like glycerine or such oil as olive oil or soybean oil. Finally, the heating element is preferably sealed in a container using high temperature TEFLON material, and/or using a silicone type material. Artisans of ordinary skill will also appreciate many possibilities for containing the heating element of the present invention and also such possibilities are comprehended as falling within the scope of applicants' claimed invention. Such containers may include bags, pouches, envelopes, and other similar materials designed for convenient and light weight use, as well as integrity for sealing and for comfort of consumer use.

In at least one embodiment of the present invention, the apparel apparatus is footwear, and such footwear is well known to include a sole. Applicants have found good consumer acceptance when the heating element described above is inserted into the sole of the footwear. Such an insertion is easily accomplished using a typical injection molding process to place the heating element in said sole of said footwear.

A method of heating the apparatus comprises the steps of obtaining the apparatus, positioning the apparatus on an inductive heating platform, maintaining the apparatus on the platform for an effective time period determined by the consumer, removing the apparatus from the platform, and wearing the apparatus. In one embodiment, the user simply wears the apparatus onto the platform and then simply walks off of the platform once sufficient heating has been obtained. Alternatively, the user may place the apparatus on the platform and set a timer or other device to allow the apparatus to obtain sufficient consumer desired temperature, and then simply wear the apparatus after removing it from the platform. An inductive beating platform generally comprises an inductive heating device, such as is well known in the art, for example as in U.S. Pat. No. 6,320,169, which is incorporated herein by reference thereto. Preferably the inductive heating device comprises an induction coil characterized with a magnetic field of frequencies between about 20 to about 50 kHz with location coupling related to the heating element, as well as to the apparel apparatus used therewith.

A method of manufacturing the apparatus comprises forming an integrated heating element as described above, inserting the heating element into an apparel apparatus, recovering the apparel apparatus and providing consumers with a kit comprising the apparel apparatus, an inductive heating device, and pertinent instructions for use. Preferably the heating element is sealed with high temperature TEFLON and/or silicone in order to provide a leak proof heating element.

In at least one embodiment of the invention, an inductive heating device is an inductive heating platform. The inductive heating platform typically uses an electromagnetic field generator comprising at least one flat coil, or “pancake”, of insulated copper wire. Preferably, the platform comprises at least two such coils situated adjacent to each other and connected in series to an alternating high frequency power source. The use of two coils typically facilitates excellent results when the platform is used with apparel that contains two heating elements such as, but not limited to, footwear or shoes. Additionally, the inductive heating device typically includes an integrated circuit timer incorporated to a switch circuit in order to turn off power after a predetermined time period. Preferably, the final time settings are user selectable which translates into different durations of apparel heat time. On/Off and Start switches are typically situated on the inductive heating device for ease of operation. When the device is a platform for items such as footwear, the switches preferably are situated in the top corners of the platform for convenient hands-free operation.

The invention will now be described with further reference to applicants' figures. Figure One represents a high temperature TEFLON bag 10. Figure Two represents a ferrous material with copper cladding 12 used to form a heating element. Figure Three represents a heating element 18 comprising a seal 14, a ferrous material with copper cladding 12, and a high temperature TEFLON bag 10. Moreover, Figure Three also shows a liquid encasing material 13 that is optionally wax or other heat transfer fluid. Figure Four represents a side view of Figure Three. Figure Five represents an embodiment of an insole with a silicone 16 jacketing around a heating element 18. Figure Six represents another embodiment where the three views of a footwear apparatus 20 are shown schematically with a dotted line heating element 18 inserted into the sole of the footwear by an injection molding process. Finally, Figure Seven represents three views of an induction heating platform 22 for whereby a footwear apparatus could be placed on the dotted lines 24.

The following examples further illustrate the invention but, of course, should not be construed as in any way limiting its scope.

### EXAMPLE 1

This example demonstrates an apparel apparatus, specifically a slipper with a rubber treaded sole that is similar to that shown in Figure Six. Two commercially available regular slippers were modified to accept insertion of an integrated heating element directly under the user's front portion of the foot. The integrated heating element was comprised of 26 gauge zinc plated ferrous sheet with copper cladding placed in a TEFLON bag (PFTE 0.0025 in. or 0.001 cm. thickness). Two bags were prepared similar to that shown in Figure Three. The first bag was filled with high flashpoint soybean oil and the second bag was filled with paraffin wax. Both bags were mechanically sealed. Finally both integrated heating elements were inserted into test slippers. The first test slipper containing the soybean oil also used additional copper above the heating element throughout sole of slipper while the second test slipper containing the paraffin wax did not.

### EXAMPLE 2

This example demonstrates an apparel apparatus, specifically an insole similar to that shown in Figure Five. The integrated heating element was a 26 gauge zinc plated ferrous sheet with copper cladding placed in a TEFLON bag (PFTE 0.0025 in. or 0.001 cm. thickness). A bag was prepared similar to that shown in Figure Three and it was filled with paraffin wax. The bag was mechanically sealed. This bag was then placed into an additional TEFLON bag. Finally, this heating element was then placed within 2 oval silicone sheets and the sheets were then sewn together.

### EXAMPLE 3

The slippers and insole from the previous examples were tested on an induction heating platform that was commercially available for use with cooking food that is similar to that shown in Figure Seven. The first slipper containing the soybean oil was activated on a medium heat setting for 25 seconds and an Infrared (“IR”) heat gun was used to check inside slipper temperature periodically. The results indicated that the first slipper containing soybean oil stayed warm between 73 to 80° F. and transferred heat for approximately 25 minutes. The second slipper was positioned over the induction heating platform and activated at medium heat setting for 25 seconds. IR heat gun measurements showed that the slipper stayed warm between 73 and 80° F. and transferred heat for approximately 25 minutes. The insole was positioned inside of footwear and was positioned over the induction heating platform and activated at medium heat for 30 seconds. IR heat gun measurements showed that the insole stayed warm at about 80 deg F. and transferred heat for approximately 30 minutes.

Thus the results on the commercially available induction heating platform confirmed the proper functioning of the invention and the benefits of the claimed invention with efficient power usage and comfortable slippers and insoles.

### EXAMPLE 4

Applicants constructed an experimental inductive heating platform with an electromagnetic field generator consisting of two flat “pancake” insulated copper wires situated adjacent to each other. The coils were fastened between wood panels to create a platform for standing upon. The coils were connected in series to the alternating high frequency power source. An integrated timer was incorporated into the design to provide an induction period equivalent to about a medium heat setting. Also incorporated were two switches in the top corners for On/Off and for Start operations.

The slippers and insole from the previous example were tested on the experimental induction heating platform to show the advantages of dual coils. The first slipper containing the soybean oil was activated on the platform for 35 seconds. The results indicated that the first slipper containing soybean oil stayed warm and transferred heat for approximately 40 minutes. The second slipper with paraffin wax was positioned over the induction heating platform and activated for 35 seconds. The results indicated that the second slipper stayed warm and transferred heat for approximately 40 minutes. The insole was positioned inside of footwear and was positioned over the induction heating platform and activated for 35 seconds. The results indicate that the insole stayed warm for approximately 40 minutes.

Thus the results on the experimental induction heating platform with dual coils confirmed the proper functioning of the invention and the benefits of the claimed invention with efficient power usage and comfortable slippers and insoles.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of heating an apparel apparatus comprising:
(a) obtaining an apparel apparatus comprising an integrated heating element comprising a ferrous compound, a copper compound, and a liquid encasing material optionally derived from wax,
(b) positioning the apparatus on an induction heating platform,
(c) maintaining the apparatus on the platform for an effective time period determined by an apparel consumer,
(d) removing the apparatus from the platform, and
(e) wearing the apparatus.

2. The method of claim 1 wherein the liquid encasing material is characterized with an effectively high heat capacity and an effectively high flash point.

3. The method of claim 1 wherein the apparatus is footwear comprising a sole.

4. The method of claim 3 wherein the heating element is inserted into the footwear using injection molding to place the heating element into the sole.

5. The method of claim 1 wherein the apparatus is an insole.

6. The method of claim 1 wherein the heating element is sealed with high temperature TEFLON, silicone, or a combination thereof.

7. The method of claim 1 wherein step (e) effectively occurs about contemporaneously with step (b).

8. The method of claim 1 wherein the induction heating platform comprises an induction coil characterized with a magnetic field of frequencies between about 20 to about 50 kHz with location coupling related to the heating element.

9. The method of claim 9 wherein the induction heating platform further comprises a second induction coil.

10. A method of manufacturing apparel for inductive heating comprising:
(a) forming an integrated heating element comprising a ferrous compound, a copper compound, and a liquid encasing material optionally derived from wax,
(b) inserting the heating element into an apparel apparatus,
(c) recovering the apparel apparatus with the heating element for use with an inductive beating device.
(d) providing apparel consumers with a kit comprising the inductive heating device, the apparel apparatus, and instructions for use.

11. The method of claim 10 further comprising the step of sealing the heating element with high temperature TEFLON or silicone.

12. The method of claim 10 wherein the apparatus is footwear comprising a sole.

13. The method of claim 12 wherein the heating element is inserted into the footwear using injection molding to place the heating element into the sole.

14. The method of claim 10 wherein the apparatus is an insole.

15. The method of claim 10 wherein the induction heating device comprises an induction coil characterized with a magnetic field of frequencies between about 20 to about 50 kHz with location coupling related to the heating element.

16. The method of claim 15 wherein the induction heating device further comprises a second induction coil.

17. An apparel apparatus for use with an inductive heating device comprising an article of consumer apparel operatively connected with a heating element comprising a ferrous compound, a copper compound, and a liquid encasing material optionally derived from wax, wherein the liquid encasing material is characterized with an effectively high heat capacity and an effectively high flash point.

18. The apparatus of claim 17 wherein the article of consumer apparel is selected from the group consisting of hats, shirts, sweaters, pants, mittens, gloves, underwear, socks, shoes, slippers, insoles, boots, jackets, coats, blouses, dresses, suits, belts, scarves, ties, and combinations thereof.

19. The apparatus of claim 18 wherein the article of consumer apparel is shoes, slippers, or boots.

20. The apparatus of claim 18 wherein the article of consumer apparel is insoles.

21. The apparatus of claim 17 wherein the copper compound is a cladding on the ferrous compound.

22. The apparatus of claim 17 wherein the liquid encasing material is an oil or an oil derived liquid.

23. The apparatus of claim 17 wherein the liquid encasing material is paraffin wax and wherein the wax undergoes a phase transition between solid state and liquid state when acting as a liquid encasing material during use with an inductive heating device.

24. The apparatus of claim 17 wherein the heating element is sealed with high temperature TEFLON and/or silicone.

25. The apparatus of claim 19 wherein the heating element is inserted into the sole of said shoes, slippers, or boots in order to provide said operative connection.

26. The apparatus of claim 20 wherein the heating element is inserted into said insoles in order to provide said operative connection.

27. The apparatus of claim 17 wherein the inductive heating device comprises at least one induction coil characterized with a magnetic field of frequencies between about 20 to about 50 kHz with location coupling related to the heating element.
